(19) United States
(12) Patent Application Publication
(10) Pub. No.: US 2015/0193794 A1
(43) Pub. Date: Jul. 9, 2015

(54) SYSTEM AND METHOD FOR GENERATING REAL-TIME CUSTOMER SURVEYS BASED ON TRIGGER EVENTS

(71) Applicant: Capital One Financial Corporation, McLean, VA (US)

(72) Inventors: Lawrence DOUGLAS, McLean, VA (US); Ronald A. SECRIST, Richmond, VA (US)

(21) Appl. No.: 14/592,315

(22) Filed: Jan. 8, 2015

Related U.S. Application Data
(60) Provisional application No. 61/924,921, filed on Jan. 8, 2014.

(51) Int. Cl. G06Q 30/02

(52) U.S. Cl. CPC G06Q 30/0203

(57) ABSTRACT

A system and method for real-time surveys includes a communication interface that receives event data associated with a customer via a network from a mobile device of the customer, a survey generator that generates a survey based on the event data, a survey transmission interface that transmits the survey to the mobile device, and a survey response receiver that receives a response to the survey. The survey generator generates one or more of follow-up commands or follow-up questions based on the received response and the survey transmission interface transmits the one or more of follow-up commands or follow-up questions to the mobile device.

### CROSS-REFERENCE TO RELATED APPLICATIONS

This application contains subject matter related to and claims the benefit of U.S. Provisional Patent Application No. 61/924,921, filed on Jan. 8, 2014, the entire contents of which is incorporated herein by reference.

### FIELD OF THE DISCLOSURE

The present disclosure relates to systems and methods for generating surveys for a customer visiting a merchant location based on one or more trigger events.

### BACKGROUND OF THE DISCLOSURE

Currently, when a customer enters a store to shop or peruse merchandise, the merchant is limited in receiving real-time feedback from the customer to gauge the customers experience. Some merchants will print a survey on the customer's receipt, or provide a web link that a customer can later visit to fill out the survey. These methods do not provide a way for the merchant to capture customer feedback data immediately and thus provide a more customer-friendly experience.

These and other drawbacks exist.

### SUMMARY OF THE DISCLOSURE

Various embodiments include systems and methods for real-time surveys. The system includes a communication interface that receives event data associated with a customer via a network from a mobile device of the customer, a survey generator that generates a survey based on the event data, a survey transmission interface that transmits the survey to the mobile device, and a survey response receiver that receives a response to the survey. The survey generator generates one or more of follow-up commands or follow-up questions based on the received response and the survey transmission interface transmits the one or more of follow-up commands or follow-up questions to the mobile device.

The method includes receiving, via a network at a communication interface, event data associated with a customer, wherein the event data is transmitted by a mobile device of the customer, generating, using a survey generator, a survey based on the event data, transmitting, using a survey transmission interface, the survey to the mobile device, receiving, via the network at a survey response receiver, a response to the survey, wherein the response to the survey is transmitted by the mobile device, generating, using the survey generator, one or more of follow-up commands or follow-up questions based on the received response; and transmitting, via the network using the survey transmission interface, the one or more of follow-up commands or follow-up questions to the mobile device.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a schematic diagram of a system for detecting a trigger event from a customer at a merchant location, generating a survey based on the trigger event, and providing the survey to the customer; and

FIG. 2 depicts a schematic diagram of a system for detecting a trigger event from a customer at a merchant location, generating a survey based on the trigger event, and providing the survey to the customer; and

FIG. 3 depicts a flow diagram of a method for detecting a trigger event from a customer at a merchant location, generating a survey based on the trigger event, and providing the survey to the customer.

### DETAILED DESCRIPTION OF THE EMBODIMENTS

The following description is intended to convey a thorough understanding of the embodiments described by providing a number of specific exemplary embodiments and details involving systems and methods for providing surveys to a customer at a merchant location based on trigger events. It should be appreciated, however, that the present disclosure is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

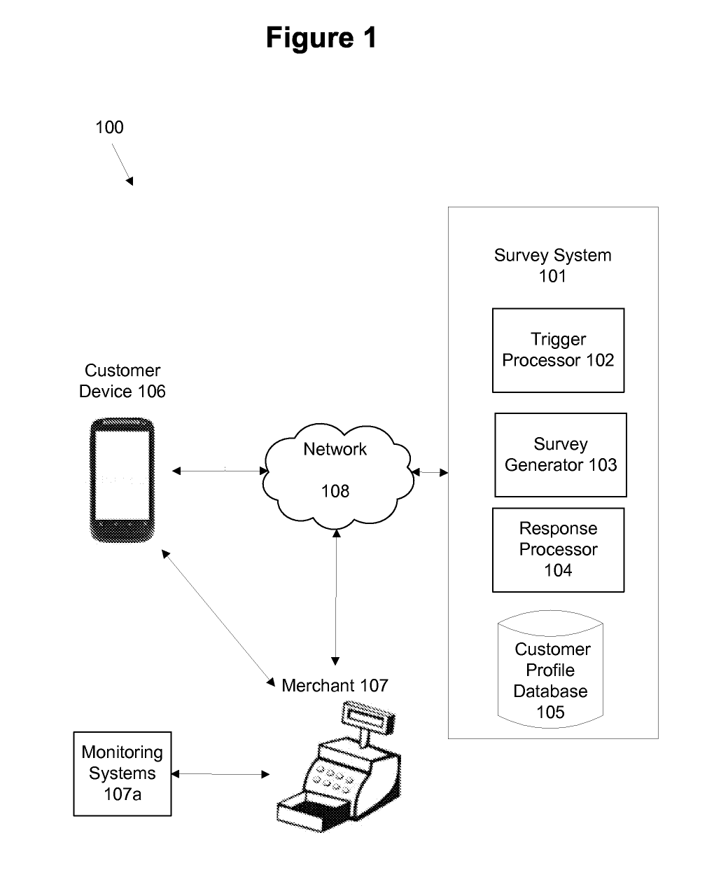

FIG. 1 depicts an example embodiment of a system 100 for providing surveys to a customer at a merchant location based on trigger events, according to various embodiments of the disclosure. The system may include various network-enabled computer systems, including, as depicted in FIG. 1 for example, a survey system 101; comprising one or more network-enabled computers, including a trigger processor 102, a survey generator 103, a response processor 104, and a customer profile database 105, which may be included as separate processors or combined into device having a single processor or device having the multiple processors. It is also noted that the system 100 illustrates only a single instance of each component. It will be appreciated that multiple instances of these components may be used. Moreover, the system 100 may include other devices not depicted in FIG. 1.

In various examples, the survey generator 103, response processor 104, customer profile database 105, and/or the trigger processor 102 may be separate from survey system 101. Survey generator 103, customer profile database 105, response processor 104, and/or trigger processor 102 also may be integrated into merchant 107. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The one or more network-enabled computer systems may also include one or more software applications to enable the creation and provisioning of services for customer device 106.

The components depicted in FIG. 1 may store information in various electronic storage media, such as, for example, customer profile database 105. Electronic information, files, and documents may be stored in various ways, including, for example, a flat file, indexed file, hierarchical database, relational database, such as a response processor created and maintained with software from, for example, Oracle® Corporation, Microsoft® Excel file, Microsoft® Access file, or any other storage mechanism.

The components depicted in FIG. 1 may be coupled via one or more networks, such as, for example, network 108. Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the exemplary types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

In various exemplary embodiments, a customer having customer device 106 may shop at a physical location of a merchant 107. A customer may have one or more accounts held at one or more financial institutions. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, an account or service that links to an underlying payment account already described, or mobile commerce account. A financial institution may be, for example, a bank, other type of financial institution, including a credit card provider, for example, or any other entity that offers accounts to customers. An account may or may not have an associated card, such as, for example, a credit card for a credit account or a debit card for a debit account. The account may enable payment using biometric authentication, or contactless based forms of authentication, such as QR codes or near-field communications. The account card may be associated or affiliated with one or more social networking sites, such as a co-branded credit card.

Survey system 101 may be operated by a financial institution, a third party, or merchant 107. Survey system 101 may interact with the customer using one or more software applications on customer device 106. The applications may provide one or more user interfaces on customer device 106 that accept inputs from the customer, provide the inputs to survey system 101 and/or merchant 107, and output information to the customer on a screen of customer device 106. The one or more software applications may be provided by survey system 101, or merchant 107, or a third party. The one or more software applications may be web-based applications and/or native mobile applications installed on the customer device 106.

The software application on customer device 106 may be linked to a customer profile stored in customer profile database 105. The customer profile may include the customer's name, phone number, email address, SSN, financial account information (such as credit card numbers, and/or bank accounts), physical address, and/or biometric information. The customer may login to the software application on customer device 106 by providing a username and/or password that are stored with the customer's customer profile in customer profile database 105.

Customer device 106 may be a PC or laptop. Customer device 106 may be a mobile device. As used herein, a mobile device may be, for example, a handheld PC, a phone, a smartphone, a PDA, a tablet computer, or other device. A mobile device also may include an iPhone, iPod, iPad from Apple® or any other mobile device running Apple's iOS operating system, any device running Google's Android® operating system, any wearable mobile device including, for example Google's wearable device, Google Glass and Samsung's Galaxy® Gear Smartwatch, any device running Microsoft's Windows® Mobile operating system, and/or any other smartphone or like wearable mobile device. Customer device 106 may include Near Field Communication (NFC) capabilities, which may allow for communication with other devices by touching them together or bringing them into close proximity. Exemplary NFC standards include ISO/IEC 18092:2004, which defines communication modes for Near Field Communication Interface and Protocol (NFCIP-1). For example, customer device 106 may be configured using the Isis Mobile Wallet™ system, which is incorporated herein by reference. Other exemplary NFC standards include those created by the NFC Forum.

Customer device 106 may be a mobile device configured to act as a method of payment at a point of sale (PoS) location (e.g., a PoS at merchant 107) using, for example, NFC or any other mobile payment technology. In this embodiment, when a customer uses customer device 106 at a PoS location to perform a financial transaction, the financial transaction may be charged to the mobile payment account. For example, the customer may use customer device 106 in lieu of (or operating as) a credit card to make a purchase merchant 107. The purchase would then be charged to the mobile payment account associated with the customer device 106. The account may be a traditional credit card account where the account holder uses a credit card, rewards card, debit card, or similar method of payment to purchase goods and services from one or more merchants 107.

Merchant 107 may include a monitoring system 107a. Monitoring system 107a may comprise one or more cameras, motion sensors, transmitters, RFID readers, and other devices for detecting a customer or customer device presence in various parts of the store. Monitoring system 107a may provide sensor data to employees and managers within merchant 107 based on customer actions. Monitoring system 107a may provide the one or more trigger signals to trigger processor 102 (along with trigger signals that may be received from customer device 106).

A customer having customer device 106 may enter a physical location of merchant 107. While the customer device 106 is within the physical location of merchant 107, one or more trigger signals may be sent to trigger processor 102, based on the customer's actions (or “events” that occur while customer is shopping or perusing merchandise within merchant 107's location). Trigger signals may be sent by customer device 106. Trigger signals may be sent by merchant 107 and/or by monitoring system 107a. Trigger signals may be associated with the customer of customer device 106 (i.e., the trigger signals may include information specifically identifying the customer, such as a name, email address, phone number, account number, biometric data, or other information that uniquely identifies the customer).

The trigger signal may include location data. Customer device 106 may include geolocation technology (such as GPS technology) and provide location data to trigger processor 102. The location data may comprise a physical address (street address, city, state, country, zip code, etc.) corresponding to customer device's 106 location. The location data may comprise GPS coordinates. The location data also may be calculated based on customer device's relative location within the physical location of merchant 107. Trigger processor 102 may analyze the location data and determine that customer device 106 is located at or nearby merchant 107 (by comparing the received location data with the known location of merchant 107). Location data may be regularly sent from customer device 106 to trigger processor 102, and trigger processor 102 may track the location of customer device 106 and update it accordingly.

The location data may also include date and time information indicating the date and time that the customer entered the store (or exited the store).

The trigger signal may be based on the customer's location within the store itself. For example, merchant 107 may comprise a number of aisles displaying different products. Each aisle may comprise one or more motion sensors or motion detectors, cameras, or like devices to determine whether an individual has passed through that aisle, or, if an individual is in the aisle, how long they linger in a certain spot. Detectors may also include Bluetooth-enabled transmitters and receivers that can detect the presence of a Bluetooth-enabled customer device 106 and triangulate the device's position within the store. Each detector may be associated with the specific products that are proximate to that detector in the aisle. When a customer enters the store, trigger processor 102 may receive a trigger signal indicating, for example, the customers presence in the store and/or the customer's relative location to an item or items. Trigger processor 102 may provide this information to merchant 107. Trigger processor 102 and/or merchant 107 may send a request to customer device 106 prompting the customer to sign in on, for example, the application user interface and/or to allow customer device 106 to broadcast its location to one or more detectors at merchant 107. Thereafter, as the customer moves through the store, merchant 107 may be able to identify where the customer is/has traveled in the store, and provide trigger signals to trigger processor 102 indicating such. The trigger signals may be time-stamped. In this way, trigger processor 102 may determine how long a customer is staying in a specific area. Customer device may automatically begin broadcasting its location to detectors within merchant 107 as soon as the customer enters the store.

The trigger signal may comprise purchase data associated with a purchase made by customer at merchant 107. The customer may purchase one or more products at merchant 107 using, for example, a mobile payment account associated with customer device 106. The customer may make the purchase using a card associated with an account stored in the customer's profile in customer profile database 105. The purchase data may comprise the date and time of purchase, the purchase amount, the product type, the name of the merchant, the purchase location, and other information associated with the purchase or the purchased products. Purchase data may include Stock Keeping Units (SKUs) associated with the purchased product or products. The purchase data may include data associated with any coupons used by the customer for the purchase. Merchant 107 may send the purchase data to trigger processor 102 as soon as the purchase is completed.

The trigger signal may comprise product data. Product data may include a Universal Product Code (UPC) of a product, an RFID tag, or other information related to the product. A customer may use customer device 106 to capture the product data (for example, using a scanner, a camera, or other device for reading product data). The customer may manually input the product data into the user interface on customer device 106. Product data may be sent by customer device 106 to trigger processor 102. Product data may be sent by merchant 107 if the customer uses a device, such as a bar code scanner attached to a display at merchant 107, to scan a bar code of a product. The scanner may be attached to a kiosk, which requests customer information (such as a name, username, password, biometric information, or other information that uniquely identifies the customer). The customer may enter his or her information at the kiosk. The customer information may be sent to trigger processor 102 along with the trigger signal, and trigger processor 102 may associate the trigger signal with the customer information.

A trigger signal may be sent by merchant 107 if the customer requests a price check on a certain product. An employee at merchant 107 may enter the product data into a network enabled computer at merchant 107, and the product data may be sent to trigger processor 102 along with customer information.

Trigger signals may be sent if the customer returns a product to the merchant 107 that the customer previously purchased. Merchant 107 may receive the product at the product returns section of the store, and may immediately send a trigger signal to trigger processor 102 that includes product data related to the returned product, as well as customer information associated with the customer who returned the product.

Merchant 107 may send trigger signals to trigger processor 102 when a customer accesses a kiosk at the store, uses a demo, or tests some item or product in the store. Merchant 107 may include one or more biometric detectors (such as body temperature, facial recognition software, or other applications) that generate trigger signals for trigger processor 102 based on the perceived mood of the customer. Merchant 107 may detect the type of clothes that the customer is wearing, and generate a trigger signal based on this information that is sent to trigger processor 102.

The trigger signals may be sent to trigger processor 102 in real-time (e.g., as soon as the triggering events are detected). Trigger processor 102 may provide the trigger signals to survey generator 103.

Survey generator 103 may create one or more surveys for customer device 106 based on the received trigger signals. As used herein, the term “survey” refers to a request for information or feedback from the customer. A survey may be presented as a notification, text message, email, SMS, MMS, or presented to the customer device on the user interface. The survey may be interactive. The survey may request additional information from the customer. The survey may be generated based on the type of trigger signal (or trigger signals) received by trigger processor 102. The survey may ask about the products purchased and/or the locations visited within the merchant. The survey may be provided to customer device 106 in real-time and/or immediately after departing the merchant's physical location. For example, the survey may be provided as a customer passes through an aisle in an attempt to receive real-time or near real-time feedback about products in that aisle. The survey also may be provided to the customer when the customer passes through a sensor upon exiting the physical location of the merchant. Surveys may include visual graphics, images, animations, videos, and other digital media for the customer. The content of a survey may depend on the type of trigger signal (or the various combinations of trigger signals) received (for example, location trigger signals, product data trigger signals, purchase data trigger signals, etc.).

In one example, a customer may enter a store location. The store or customer device may detect, using various sensors discussed herein, for example, the customer's presence and provide a trigger signal to trigger processor 102 indicating the customer's presence in the store. The store or customer device may then detect that the customer has left the store without making a purchase (e.g., if the trigger processor 102 does not receive purchase data a predetermined time after the customer enters or leaves the store). Survey generator 103 may create a survey and transmit it to the customer. The survey may solicit feedback from the customer, and may include one or more questions for the customer, such as “Did you find what you were looking for?”, “Was the item you found too expensive?”, or “What item were you looking for?” The survey may be transmitted to customer device 106 as soon as it is determined that the customer has left the store. The survey also may be transmitted to customer device 106 if the customer has not made a purchase within a predetermined time after the customer entered the store. The survey may be interactive, and provide further questions to the customer based on how the customer responds to the initial query or queries.

The survey may be interactive and prompt the customer to respond using a key on a keypad (e.g., depress a key, scroll a wheel, etc.), clicking the screen using a mouse or other peripheral device connected to the customer device 106, pressing a button on the side of customer device 106, by touching one or more responses on a touchscreen of customer device 106, by speaking a selection, by use a motion (e.g., customer device 106 may include a gyroscope or other motion detector to detect when the customer moves the device a certain angle, or shakes, swings, maneuvers, and/or otherwise moves customer device 106, etc.). The customer's responses may be received by response processor 104. The response processor 104 or survey generator 103 may create and transmit additional survey queries based on the responses received from customer device 106. The responses may be saved with the customer's profile information in customer profile database 105.

The survey may ask the customer to rate their experience (for example, on a scale of 1 to 10 and/or other similar scales (e.g., like, neutral, dislike)). The survey may ask the customer to rate products (for example, by assigning one to five stars to a product). The survey may prompt the customer to select one of several options for an answer. The survey may provide one or more text boxes for the customer to input a text-based answer to a survey question.

Continuing with the previous example, if the customer indicates in a response that he did not find the item he was looking for at that physical store, response processor 104 may send a follow-up survey to customer device 106 that includes a link to the merchant's online site where the customer can purchase the specific item. The follow-up survey may provide directions to a nearby store where the customer can purchase the item. The survey may provide information about similar or related items sold at that particular store where the customer was just shopping. The survey may ask the customer if he or she would like to be contacted by a customer service representative from that store.

In various embodiments, merchant 107 or customer device 106 may send one or more trigger signals to trigger processor 102 indicating the customer's location within the store. If trigger processor 102 determines that the customer has lingered at a certain section of the store for a predetermined amount of time (for example, more than 30 seconds), survey generator 103 may send one or more surveys to customer device 106. The surveys may ask the customer if he or she would like more detailed information about the product or products he or she is currently looking at. The trigger signal may be sent to an employee or manager of merchant 107, indicating the customer's location and requesting assistance. The survey may ask the customer if he or she would like to be assisted by a customer service representative. The survey may provide the customer with information about similar products, discounts, coupons, sales, or deals related to the product the customer is currently nearby within the store.

In another example, merchant 107 or customer device 106 may send one or more trigger signals to trigger processor 102 when the customer purchases one or more products at the store. Survey generator 103 may create one or more surveys based on the purchase data and send them to customer device 106. The survey may request information from the customer about various aspects of the customer's shopping experience (e.g., the quality of customer service, the competitive nature of the prices for each product, the quality of the store, the availability of discounts).

Trigger processor 102 may receive one or more trigger signals based on the customer device 106 scanning or capturing product data from a product (such as the UPC or an RFID tag). In response, survey generator 103 may send one or more surveys to customer device 106 including additional information about the product. The survey may include questions asking if the customer would like assistance. The survey may include one or more coupons or discounts related to the scanned product. The survey may ask the customer if he is interested in learning about online deals related to the product or similar products.

In another example, trigger processor 102 may receive one or more trigger signals based on biometric information detected at merchant 107. For example, one or more temperature sensors may detect an elevated temperature of a customer. One or more facial recognition sensors or applications may detect expressions on a customer indicating confusion, boredom, frustration, or other emotions. The trigger signals may be sent to trigger processor 102. Based on these signals, survey generator 103 may generate one or more surveys for customer device 106 that ask the customer if he or she needs help, has a question about a product, would like assistance from a sales representative, or other information.

Survey generator 103 also may transmit surveys to one or more stations or kiosks at merchant 107. The stations or kiosks may be network-enabled computers at fixed locations around merchant 107. For example, if the trigger signal indicates that a customer is lingering in a specific aisle of the store, and a kiosk is in or near that aisle, the survey generator may send a survey to that kiosk and provide an audible signal for the nearby customer, requesting a response or feedback.

Trigger signals and/or survey responses may be provided to merchant 107 in real-time. Employees and managers at merchant 107, and, for example, the systems associated therewith may receive survey responses and/or trigger signals, allowing them to address issues as they arise and provide a better overall experience for the customer. Trigger signals and surveys may be transmitted in real-time.

Customer responses to surveys may be stored with the customer's profile information at profile database 105. Merchant survey system 101 may provide deals, discounts, coupons, and other incentives to customers based on the number and quality of survey responses received.

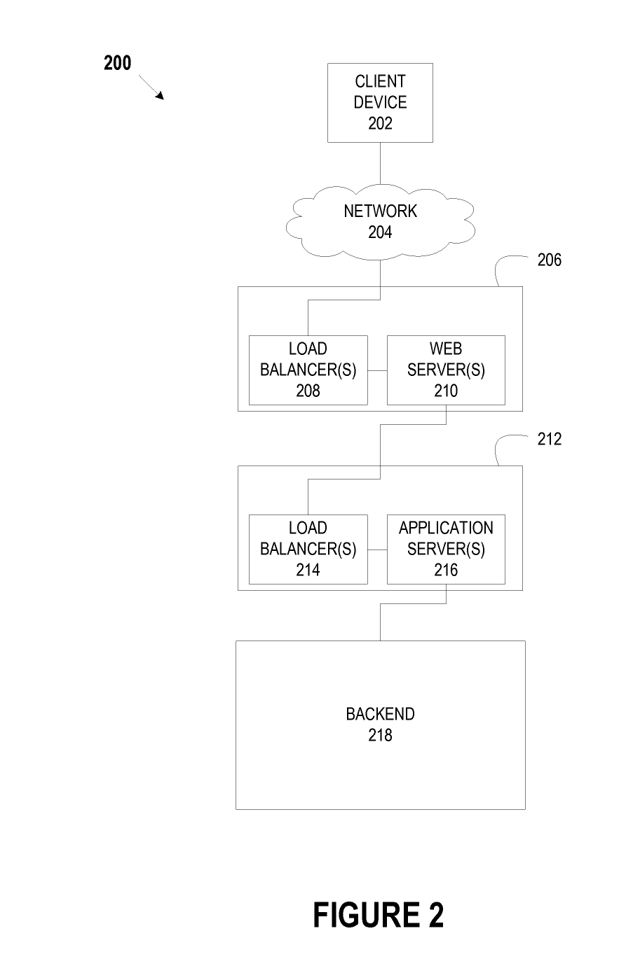

FIG. 2 depicts an example system 200 that may enable a real-time trigger system and or merchant, for example, to provide network services to its customers. As shown in FIG. 2, system 200 may include a client device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

Client device 202 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

Client device 202 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device. In various embodiments, client device may be similar to customer device 106.

Network 204 may be one or more of a wireless network, a wired network, or any combination of a wireless network and a wired network. For example, network 204 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN) or a global network such as the Internet. Also, network 110 may support an Internet network, a wireless communication network, a cellular network, or the like, or any combination thereof. Network 204 may further include one network, or any number of example types of networks mentioned above, operating as a stand-alone network or in cooperation with each other. Network 204 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 208 may distribute workloads across, for example, web server(S) 210 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 and 214 may include software that monitoring the port where external clients, such as, for example, client device 202, connect to access various services of a financial institution, merchant, or third party that offers a survey system (such as survey system 101 shown in FIG. 1), for example. Load balancer(s) 208 may forward requests to one of the application servers 216 and/or backend 218 servers, which may then reply to load balancer 208. This may allow load balancer(s) 208 to reply to client device 202 without client device 202 ever knowing about the internal separation of functions. It also may prevent client devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., client device 202) through a network (e.g., network 204), such as the Internet. In various examples, web servers, may deliver web pages, relating to, for example, online banking applications and the like, to clients (e.g., client device 202). Web server(s) 210 may use, for example, a hypertext transfer protocol (HTTP or sHTTP) to communicate with client device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 210 may respond with the content of that resource or an error message if unable to do so. The resource may be, for example a file on stored on backend 218. Web server(s) 210 also may enable or facilitate receiving content from client device 202 so client device 202 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution or other entity implementing system 200 and/or system 101, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 210 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution or other entity that maintains a distributes system similar to system 200 and/or survey system 101. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, a survey system platform (e.g., for survey system 101 shown in FIG. 1) and the like. Backend 218 may be associated with various databases, including account databases that maintain, for example, customer account information, product databases that maintain information about products and services available to customers, content databases that store content associated with, for example, a financial institution, and the like. Backend 218 also may be associated with one or more servers that enable the various services provided by system 200. Backend 218 may be associated with one or more servers that enable the various services provided by survey system 101.

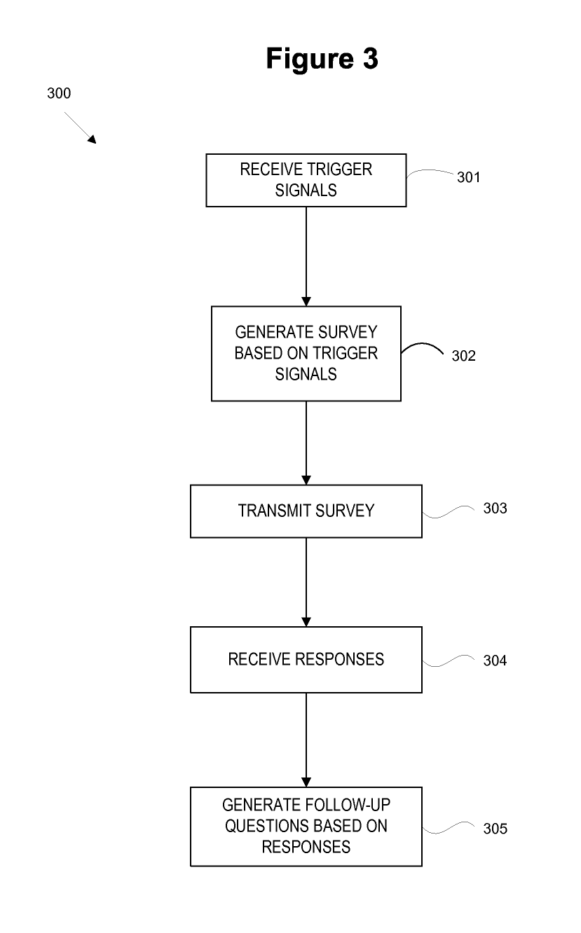

FIG. 3 is a flow chart illustrating a method for generating surveys for customers based on trigger events at a merchant location. This exemplary method is provided by way of example. The method 300 shown in FIG. 3 can be executed or otherwise performed by one or more combinations of various systems. The method 300 as described below may be carried out by the system shown in FIG. 1, by way of example, and various elements of that system are referenced in explaining the method of FIG. 3. Each block shown in FIG. 3 represents one or more processes, methods, or subroutines in the exemplary method 300. Referring to FIG. 3, the exemplary method 300 may begin at block 301.

In block 301, trigger signals may be received. For example, when a customer enters a merchant physical store location, the customer device 106, merchant 107, and/or trigger processor 102 may detect the customer's presence at or in the store. A user interface on customer device 106 may prompt the customer to enter login information, such as a username and password. If the customer has previously shopped at the store, the customer may have previously indicated that the store may track the customer's location. The customer may be prompted by the user interface on customer device 106 to confirm his presence in the store. Thereafter, trigger processor may receive one or more trigger signals from merchant 107 and/or customer device 106 based on customer actions in the store.

Trigger signals may be based, for example, on the customer's location within the store, the amount of time the customer spends in a certain area of the store, whether the customer purchases anything in the store, what products the customer purchases, whether the customer scans product data or requests a price check on one or more products in the store, temperature data associated with the customer, facial recognition data associated with the customer, whether the customer returns items to the store, and other information.

For example, a customer may enter a Target® location, prompting a trigger signal to be sent indicating the customer is in the store (e.g., the physical location of the merchant which may include any physical boundaries established by the merchant relative to the store). The trigger signal may be sent by customer device 106 and/or one or more transmitters in the Target® store. The customer may spend ten minutes in the electronics department in the digital television aisle, prompting one or more trigger signals to be sent to trigger processor 102. These trigger signals indicate the location of the store where the customer is (electronics department, digital television aisle), how long the customer was there (ten minutes), and other relevant information. The customer may then return a pair of headphones at the returns department, prompting another trigger signal that includes information about the returned product (headphones). Finally, the customer may leave, prompting another trigger signal indicating the time the customer left. Each of these trigger signals may be received and analyzed by trigger processor 102. Trigger signals may also be received and analyzed by merchant 107. Trigger signals may be sent to store employees at merchant 107. Method 300 may proceed to block 302.

At block 302, one or more surveys may be generated based on the received trigger signals. The surveys may include a plurality of questions or queries for the customer, based on the received trigger signals. The surveys may be interactive and solicit customer responses. Continuing with the previous example, survey generator may receive the trigger signals from trigger processor 102 and generate one or more surveys. Survey processor may generate a first survey for the customer based on his location in Target and the amount of time he spent there. Survey generator 103 may be configured to generate a survey with questions relating to specific products if the customer spent at least a predetermined amount of time in an area proximate to those products. The amount of time may vary depending on the type of product. For the customer in Target®, survey generator 103 may generate a survey with information about digital televisions. The survey may ask the customer if he is interested in learning more about digital televisions offered at Target.com. The survey may ask the customer if he would like assistance from a store employee. The survey may ask the customer what brand of television he is looking for.

Survey generator 103 may generate a survey based on the customer's returning the headphones. The survey may ask the customer if he is interested in purchasing a new pair. The survey may ask the customer what was wrong with the headphones. The survey may ask the customer whether he would like in-store credit. The survey may offer the customer a discount on his next purchase.

Survey generator 103 may generate a survey based on the trigger signal indicating he has left the store. The survey may ask the customer to rate his experience, the products, the prices, the facilities, the customer service, and whether he would recommend the store to friends. The survey generator 103 may detect that the customer never purchased any products (as no trigger signal was received that would indicate this). The survey may ask the customer whether he would like to be contacted by a customer sales representative. Method 300 may proceed to block 303.

In block 303, the survey may be transmitted to the customer. The survey may be transmitted in real-time as it is generated. The survey may be transmitted to the customer's customer device 106 as described above. Customer device 106 may be a mobile device, such as a smartphone. Surveys may be transmitted to one or more kiosks and/or other network enabled computers within merchant 107. Method 300 may proceed to block 304.

At block 304 receive responses to the survey may be received from the customer. The survey may be interactive. The customer may select one or more pre-defined responses to each question. The customer may enter responses in a text box. Customer may enter responses using customer device 106. Responses may be sent to merchant 107 by the customer device using, for example the systems illustrated in FIGS. 1 and 2. Employees, using for example the systems shown and described in FIGS. 1 and 2, may see one or more responses to surveys and may be prompted to follow-up with the customer if the customer is still in the store, for example. Employees may be prompted to follow up with the customer via a phone call or email after the customer has left. Method 300 may proceed to block 305.

At block 305, follow-up actions to take based on the customer responses may be determined. If a customer responds to the survey requesting more information, response processor 104 may send the customer the information that he or she requested. Survey generator 103 may provide additional surveys to the customer based on the responses received. Continuing with the previous example, the customer may receive a survey after he leaves Target. The survey may ask the customer why he did not purchase anything. One of the optional responses may include “Could not find the product I was looking for.” If the customer selects this option, and the response is received at response processor 104, survey generator 103 may transmit a follow-up survey question, asking the customer to select the type of product he was looking for (e.g., “electronics”, “clothing”, “furniture”, “toys”, “appliances”). The follow-up question may assume the customer was looking for a digital television based on the triggers received indicating he spent 10 minutes in the digital television aisle. The follow-up question may ask the customer if he would be interested in seeing deals on electronic televisions on the merchant website. The follow-up question may ask the customer which brand he is looking for. This may prompt additional information for the customer. The customer's responses may be stored in a profile database. Other surveys may be generated based on previously stored responses and customer information.

It is further noted that the software described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

I claim:

1. A system, comprising:
a communication interface that receives event data associated with a customer via a network from a mobile device of the customer;
a survey generator that generates a survey based on the event data;
a survey transmission interface that transmits the survey to the mobile device; and
a survey response receiver that receives a response to the survey,
wherein the survey generator generates one or more of follow-up commands or follow-up questions based on the received response, and
wherein the survey transmission interface transmits the one or more of follow-up commands or follow-up questions to the mobile device.

2. The system of claim 1, wherein the survey transmission interface transmits the survey to the mobile device via email.

3. The system of claim 1, wherein the survey transmission interface transmits the survey to the mobile device via a short message service (SMS) message.

4. The system of claim 3, wherein the SMS message includes a link to the survey.

5. The system of claim 1, wherein the survey transmission interface transmits the survey to the mobile device via a push notification.

6. The system of claim 1, wherein the event data indicates that the customer has entered a physical location associated with a merchant.

7. The system of claim 1, wherein the event data indicates that the customer has remained at a particular location within a merchant location for a threshold amount of time.

8. The system of claim 1, wherein the event data indicates that the customer has exited a physical location associated with a merchant.

9. The system of claim 1, wherein the event data indicates that the customer has purchased a particular item from a merchant.

10. The system of claim 1, wherein the customer uses a mobile application to input and transmit the response.

11. A method, comprising:
receiving, via a network at a communication interface, event data associated with a customer, wherein the event data is transmitted by a mobile device of the customer;
generating, using a survey generator, a survey based on the event data;
transmitting, using a survey transmission interface, the survey to the mobile device;
receiving, via the network at a survey response receiver, a response to the survey, wherein the response to the survey is transmitted by the mobile device,
generating, using the survey generator, one or more of follow-up commands or follow-up questions based on the received response; and
transmitting, via the network using the survey transmission interface, the one or more of follow-up commands or follow-up questions to the mobile device.

12. The method of claim 11, further comprising:
transmitting, using the survey transmission interface, the survey to the mobile device via email.

13. The method of claim 11, further comprising:
transmitting, using the survey transmission interface, the survey to the mobile device via a short message service (SMS) message.

14. The method of claim 13, wherein the SMS message includes a link to the survey.

15. The method of claim 11, further comprising:
transmitting, using the survey transmission interface, the survey to the mobile device via a push notification.

16. The method of claim 11, wherein the event data indicates that the customer has entered a physical location associated with a merchant.

17. The method of claim 11, wherein the event data indicates that the customer has remained at a particular location within a merchant location for a threshold amount of time.

18. The method of claim 11, wherein the event data indicates that the customer has exited a physical location associated with a merchant.

19. The method of claim 11, wherein the event data indicates that the customer has purchased a particular item from a merchant.

20. The method of claim 11, wherein the customer uses a mobile application to input and transmit the response.
